(19) United States
(12) Patent Application Publication
(10) Pub. No.: US 2011/0055013 A1
(43) Pub. Date: Mar. 3, 2011

(54) SECURE ALERT SYSTEM AND METHOD

(76) Inventor: Ayman Hammad, Pleasanton, CA (US)

(21) Appl. No.: 12/617,268

(22) Filed: Nov. 12, 2009

Related U.S. Application Data
(60) Provisional application No. 61/237,801, filed on Aug. 28, 2009.

(51) Int. Cl. G06Q 10/00; G06Q 30/00; G06F 15/16

(52) U.S. Cl. 705/14.53; 705/325; 709/204

(57) ABSTRACT

A method for receiving transaction data for a transaction, accessing a database comprising alert preference data, and generating a secure alert message using the transaction data and alert preference data using a notification server coupled to the database. The secure alert message comprises a dynamic identifier personal to the consumer. The method also includes sending the secure alert message to a consumer device.

### CROSS-REFERENCES TO RELATED APPLICATIONS

This application claims benefit under 35 U.S.C. §119(e) of U.S. provisional patent application No. 61/237,801, filed on Aug. 28, 2009, the entire disclosure of which are incorporated herein by reference for all purposes.

### BACKGROUND

There are many occasions where a user may want to be notified when his credit card is being used. For example, a user may want to receive an alert message regarding a recent transaction conducted at a gas station or with an online merchant. The alert message may contain transaction data such as the amount of the transaction, the time the transaction occurred, and the name of the merchant. The alert message may be sent to the user's mobile phone.

As alerts continue to be utilized by an ever increasing number of users, so does the potential for fraudulent and criminal activity. Phishing is becoming more prevalent and is a growing concern that can take different forms. For example, a “phisher” can target an unsuspecting user with a fake alert message that is an attempt to elicit the user to respond with personal and/or financial information. A fake alert message may entice an unsuspecting user to visit a phishing Web site and enter personal and/or financial information which is captured at the phishing Web site.

Embodiments of the present invention address these problems and other problems individually and collectively.

### BRIEF SUMMARY

Embodiments of the present invention disclosed herein include systems and methods for sending secure alert messages. The secure alert message system can be implemented using one or more computer apparatuses and databases.

One embodiment of the invention is directed to a notification server comprising a processor, and a computer-readable medium coupled to the processor, the computer-readable medium comprising code executable by the processor for implementing a method comprising receiving transaction data for a transaction, generating a secure alert message using the transaction data, wherein the secure alert message comprises a dynamic identifier, and sending the secure alert message to a notification device.

Another embodiment of the invention is directed to a method for receiving transaction data for a transaction, generating a secure alert message using the transaction data, wherein the secure alert message comprises a dynamic identifier, and sending the secure alert message to a notification device.

Yet another embodiment of the invention is directed to a method comprising conducting a transaction using an account identifier and receiving a secure alert message associated with the transaction at a notification device. The secure alert message was generated by a notification server computer. The alert message comprises a dynamic identifier.

These and other details regarding embodiments of the invention are provided below.

### BRIEF DESCRIPTION OF THE DRAWINGS

FIG. 1 shows a diagram illustrating a secure alert messaging system.

FIG. 2 shows a diagram illustrating more details of portions secure alert messaging system.

FIG. 3 shows a flowchart illustrating the steps involved in enrolling and updating a consumer in the enrollment database.

FIG. 4 shows a flowchart illustrating the steps involved when a consumer conducts a transaction according to an embodiment of the invention.

FIG. 5 is an illustration of a secure alert message according to an embodiment of the invention.

FIG. 6 shows a block diagram of components of a computer apparatus.

### DETAILED DESCRIPTION

One embodiment of the invention is directed to a method for sending a secure alert message to a consumer after a transaction is conducted with a portable consumer device. The secure features of the alert message help a consumer to distinguish an authentic alert message from a non-authentic alert message.

In one embodiment, the method comprises, receiving transaction data for a transaction. The transaction data may be present in an authorization request message. For example, a consumer can conduct a transaction using a portable consumer device such as a credit card. The authorization request message comprising the transaction data is sent to an acquirer, and then to a payment processing network. The payment processing network then determines if the consumer is enrolled to receive secure transaction alert messages. If the consumer is enrolled, then the transaction data, which may include account information and merchant data, are sent to an IP (Internet protocol) gateway. The IP gateway then receives the transaction data.

After receiving the transaction data from the payment processing network, a notification server computer in the IP gateway accesses a database which can comprise alert preference data. The alert preference data may be used to format the secure alert message. Preferences may come from the consumer who is receiving the alert message or a merchant. Consumer preference data may include security phrases or images previously chosen by the consumer. Merchant preference data may include advertisements, specifically chosen by the merchant to be included in the secure alert message.

Yet other data which may be included in the secure alert message may be the current value of dynamic identifier associated with the consumer's transactions. In one embodiment, the dynamic identifier can be a transaction counter which increments each time the consumer conducts a transaction with a payment card (or other type of portable consumer device). An unauthorized entity that is trying to send a fake transaction alert message to the consumer would not know the current value of the transaction counter. For example, a consumer may conduct a legitimate transaction and may receive an authentic transaction alert message which may include a transaction counter value “14” which indicates that the 14^{th} transaction of the month was conducted by the consumer. If the next transaction alert message received by the consumer contains a transaction counter “2” or does not have a transaction counter value, then the consumer may conclude that the transaction alert message is fraudulent and need not respond to the transaction alert message.

After determining the content for the secure transaction alert message, the notification server then sends the secure transaction alert message to the consumer's notification device. The notification device may be the consumer's mobile phone or computer. The secure transaction alert message may comprise a security image, an advertisement, and the previously described dynamic identifier.

I. Systems

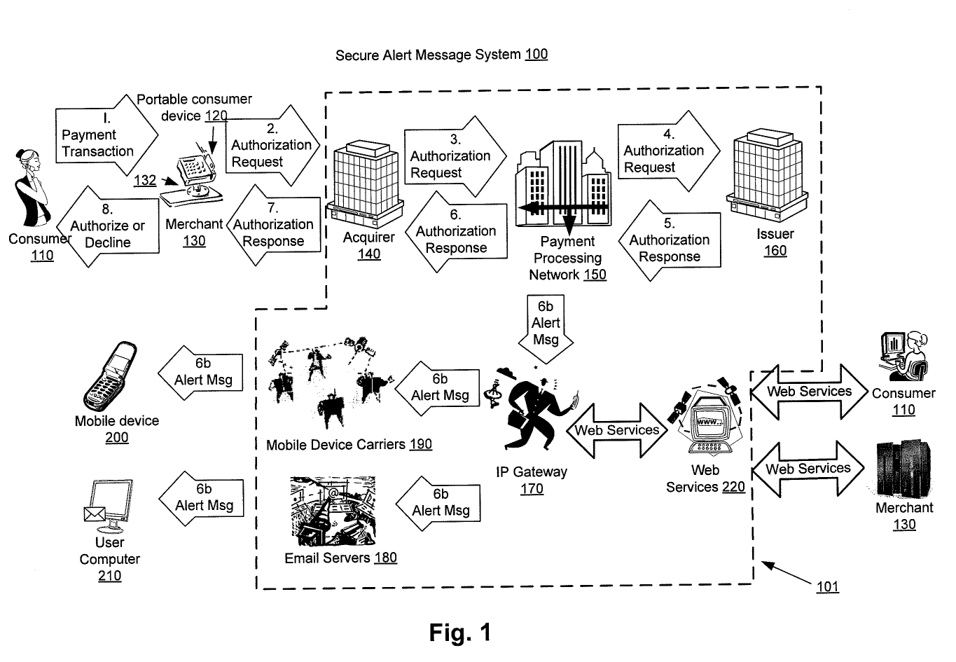

FIG. 1 shows a system according to an embodiment of the invention. Note that embodiments of the invention may use all or only some of the components shown in FIG. 1.

FIG. 1 is a diagram illustrating a secure alert messaging system 100. FIG. 1 shows a consumer 110, a portable consumer device 120, a merchant 130, an access device 132, an acquirer 140, a payment processing network 150, an issuer 160, an IP gateway 170, mobile device carriers 190, e-mail servers 180, a mobile device 200, a user computer 210, and Web services 220. Although one consumer 110, one mobile device 200, one user computer 210, one merchant 130, and one issuer 160 are shown, there may be any suitable number of any of these entities in a secure alert messaging system 100.

The consumer 110 is in operative communication with the portable consumer device 120. Merchant 130 has an access device 132 for interacting with the portable consumer device 120 and the acquirer 140 associated with the merchant 130. Acquirer 140 is in communication with issuer 160 through payment processing network 150.

The secure alert messaging system 100 also includes a mobile device 200 in operative communication with consumer 110 for displaying secure alert messages to the consumer 110.

The secure alert message system 100 also includes an IP gateway 170 that is in communication with payment processing network 150. IP gateway 170 receives the transaction data from the payment processing network 150 and generates the secure alert messages. IP gateway 170 is also in communication with the mobile device carriers 190, e-mail servers 180, and Web services 220. The mobile device carriers 190 are in operative communication with the mobile device 200, and the mail servers 180 are in operative communication with the user computer 210. The secure alert messages that are generated from IP gateway 170 are sent to the mobile device carriers 190 and/or mail servers 180 to be sent to the mobile device 200, and/or to be accessed by the user computer 210. The Web services 220 is also in operative communication with a consumer 110 for enrolling the consumer 110 in the messaging service provided by the secure alert messaging system 100. The Web services 220 is also in operative communication with a merchant 130 for enrolling merchant 130 in the messaging service provided by the secure alert messaging system 100.

Consumer 110 refers to an individual or organization such as a business that is capable of purchasing goods or services or making any suitable transaction with a merchant 130.

Portable consumer device 120 refers to any suitable device that allows the transaction to be conducted with merchant 130. Portable consumer device 120 may be in any suitable form. For example, suitable portable consumer devices 120 can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of portable consumer devices 120 include cellular phones, personal digital assistants (PDAs), pagers, payment cards, security cards, access cards, smart media, transponders, and the like. In some cases, portable consumer device 120 may be associated with an account of consumer 110 such as a bank account or a credit card account.

Merchant 130 refers to any suitable entity or entities that can conduct a transaction with the consumer 110. Merchant 130 may use any suitable method to make the transaction. For example, merchant 130 may use an e-commerce business to allow the transaction to be conducted by merchant 130 through the Internet. Other examples of merchant 130 include a department store, a gas station, a drug store, a grocery store, or other suitable business.

Access device 132 may be any suitable device for communicating with merchant 130 and for interacting with portable consumer device 120. Access device 132 can be in any suitable location such as at the same location as merchant 130. Access device 132 may be in any suitable form. Some examples of access devices 132 include POS devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. Access device 132 may use any suitable contact or contactless mode of operation to send or receive data from portable consumer devices 120.

If access device 132 is a POS terminal, any suitable POS terminal may be used and may include a reader, a processor, and a computer-readable medium. Reader may include any suitable contact or contactless mode of operation. For example, exemplary card readers can include radio frequency (RF) antennas, optical scanners, bar code readers, magnetic stripe readers, etc. to interact with portable consumer device 120.

Acquirer 140 refers to any suitable entity that has an account with merchant 130. In some embodiments, issuer 160 may also be acquirer 140.

Payment processing network 150 refers to a network of suitable entities that have information related to an account associated with portable consumer device 120. This information includes data associated with the account on portable consumer device 120 such as profile information, data, and other suitable information.

Payment processing network 150 may have or operate a server computer and may include a database. The database may include any hardware, software, firmware, or combination of the preceding for storing and facilitating retrieval of information. Also, the database may use any of a variety of data structures, arrangements, and compilations to store and facilitate retrieval of information. The server computer may be coupled to the database and may include any hardware, software, other logic, or combination of the preceding for servicing the requests from one or more client computers. Server computer may use any of a variety of computing structures, arrangements, and compilations for servicing the requests from one or more client computers.

Payment processing network 150 may include data processing subsystems, networks, and operations used to support and deliver authorization services, exception file services, and clearing and settlement services. An exemplary payment processing network 150 may include VisaNet™. Networks that include VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. Payment processing network 150 may use any suitable wired or wireless network, including the Internet.

Issuer 160 refers to any suitable entity that may open and maintain an account associated with portable consumer device 120 for consumer 110. Some examples of issuers may be a bank, a business entity such as a retail store, or a governmental entity. In many cases, issuer 160 may also issue portable consumer device 120 associated with the account to consumer 110.

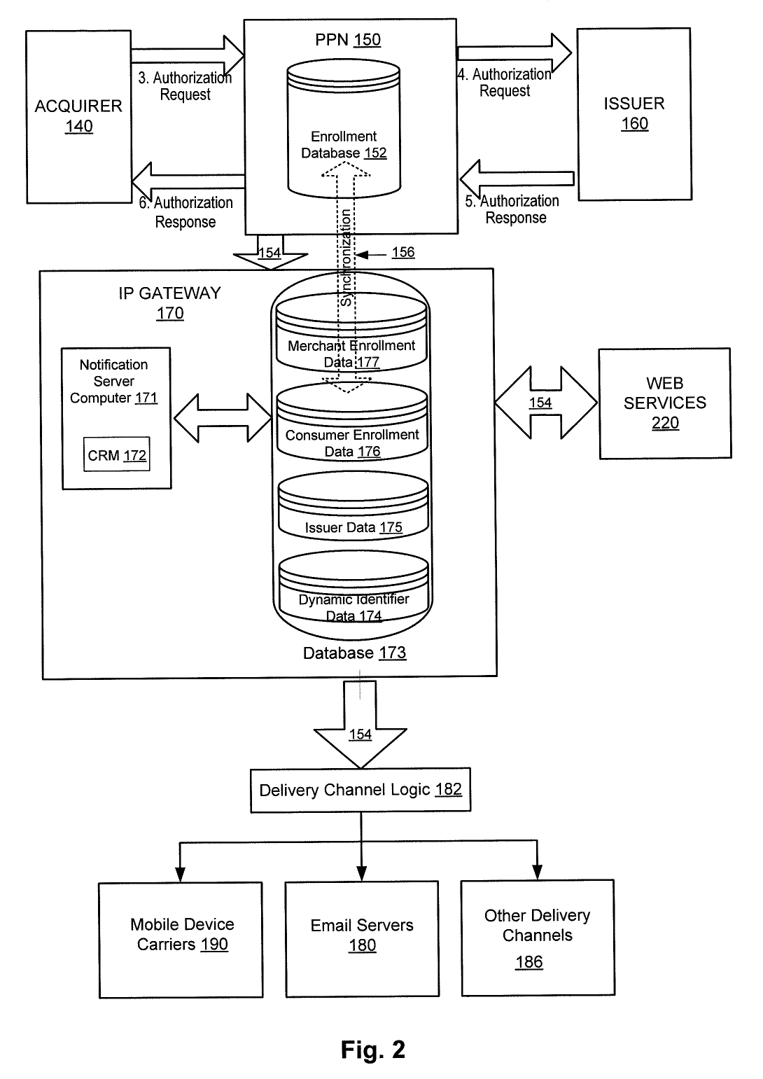

FIG. 2 is a diagram illustrating a subsystem 101 of the secure alert messaging system 100. FIG. 2 illustrates more details associated with the IP gateway 170. The IP gateway 170 includes a notification server computer 171 having a computer-readable medium 172, and a processor (not shown) that is coupled to the computer readable medium 172. The notification server computer 171 is in communication with a database 173. The notification server computer 171 comprises a processor (not shown) and a computer-readable medium 172 coupled to the processor, the computer-readable medium comprising code executable by the processor for implementing a method comprising receiving transaction data for a transaction, generating a secure alert message using the transaction data using the notification server computer, wherein the secure alert message comprises a dynamic identifier, and sending the secure alert message to a notification device.

A database 173 may be coupled to the notification server computer 171. The database 173 contains data that are used to generate the secure alert messages. The data includes dynamic identifier data 174, issuer data 175, consumer enrollment data 176, and merchant enrollment data 177.

Consumer enrollment data 176 are synchronized with the enrollment database 152 via the synchronization link 156. The enrollment database 152 contains data related to consumers who are enrolled in the messaging service. As shown in FIG. 2, IP gateway 170 is in communication with payment processing network 150, and Web services 220 via the network connection 154 which may be in any suitable form. The network connection 154 may include, for example, at least a portion of the Internet. Delivery channel logic 182 is in communication with IP gateway 170, mobile service carriers 190, e-mail servers 180, and other delivery channels 186.

IP gateway 170 refers to an entity that generates and delivers notifications and secure alert messages to various delivery channels. IP gateway 170 may include one or more servers and databases for the generation of the secure alert messages and the retrieval of data. IP gateway 170 may be part of the payment processing network 150 or may be a separate entity in communication with payment processing network 150.

Delivery channel logic 182 may be in the form of an application program that sends the secure alert messages to the appropriate delivery channel. Delivery channel logic 182 may be part of the IP gateway 170 or the payment processing network 150. In some embodiments, delivery channel logic runs on a server computer that is in communication with the notification server computer 171. In other embodiments, delivery channel logic may run on the notification server computer 171.

E-mail servers 180 are server computers configured to receive an e-mail from a network connection and store the e-mail in memory for future retrieval.

Mobile device carriers 190 refer to entities that provide wireless infrastructures for wireless data transfer and communication via cellular phone or other mobile devices. Examples of such entities are AT&T™, Verizon Wireless™, T-Mobile™, etc.

Referring again to FIG. 1, mobile device 200 may be in any suitable form. For example, suitable mobile device 200 can be hand-held and compact so that they can fit into a consumer's wallet and/or pocket (e.g., pocket-sized). Some examples of mobile device 200 include desktop or laptop computers, cellular phones, personal digital assistants (PDAs), pagers, and the like. In some embodiments, mobile device 200 and portable consumer device 120 are embodied in the same device. The mobile device 200 is an example of a notification device. The notification device may comprise a processor and a computer readable medium. The computer readable medium may comprise code, executable by the processor, to implement a method comprising receiving the secure alert messages according to embodiments of the invention, and then displaying them to the consumer.

User computer 210 may be a personal computer or a laptop. The User computer 210 may run an operating system such as Microsoft Windows™ and may have a suitable browser such as Internet Explorer™.

Web services 220 may be in the form of a server and a Website which allows users and merchants to enroll in the messaging service. Web services 220 may be provided by the issuer 160 or the payment processing network 150.

II. Methods

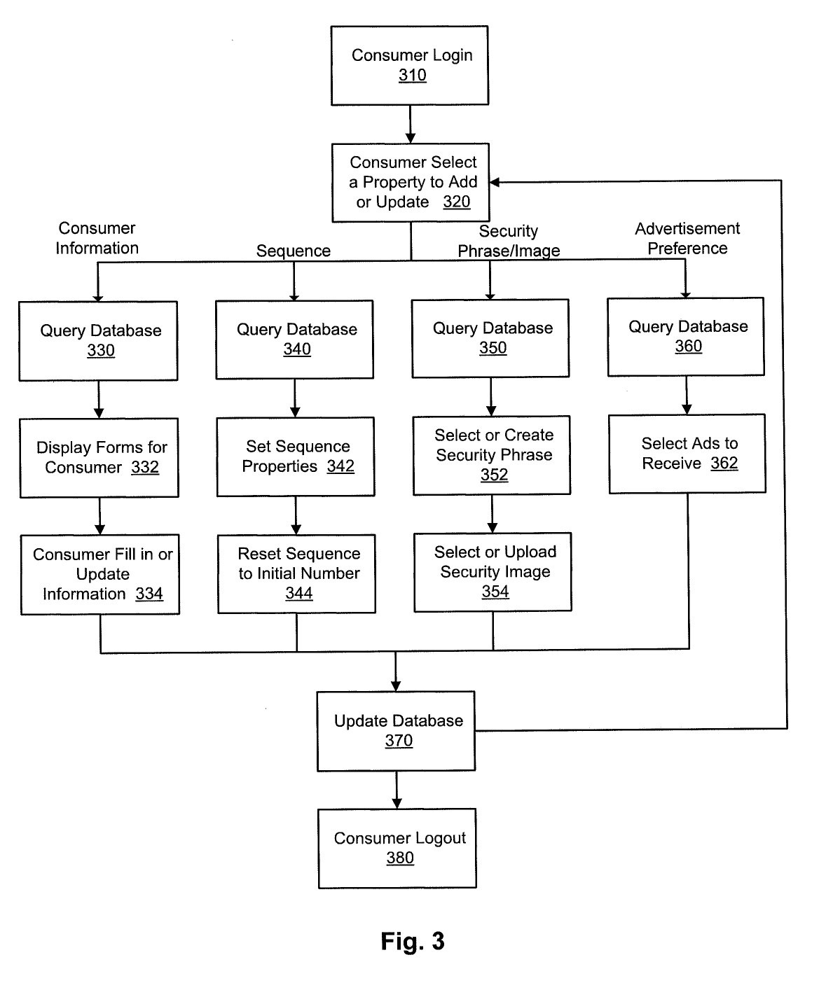

As shown in FIG. 1, consumer 110 and merchant 130 may enroll in the secure alert messaging service through the Web services 220. A consumer or a merchant may also enroll though issuer 160. FIG. 3 is a flow diagram that illustrates the steps of enrollment of a consumer to the secure alert messaging service through the Web services 220. The consumer provides data regarding his preferences after the consumer logs into the enrollment server. The data is then stored in the database.

### A. Enrollment

In order to receive the secure alert messages associated with a transaction, a consumer 110 enrolls in the secure alert messaging service. One or more merchants may also enroll in the alert messaging service to provide advertisements to one or more consumers.

There are multiple ways for a consumer 110 to enroll in the messaging service. In some embodiments, consumer 110 may be enrolled automatically by the issuer 160 that issues the portable consumer device 120. Enrollment for a consumer may also be done in a batch mode, by file delivery from issuer 160 or by file delivery from some other party. In other embodiments, issuer 160 or payment processing network 150 may provide the messaging service as an option to consumer 110 at which time consumer 110 may enroll in the messaging service either by contacting a customer service representative over the phone (provided either by issuer 160 or payment processing network 150), or by accessing a Web site and filling out an online application. In certain implementations, the Web site may be hosted by one entity but can redirect the consumer to a site hosted by another entity. Similarly, merchant 130 may enroll in the messaging service either through issuer 160 or payment processing network 150, or by accessing a Web site and filling out an online application.

During the enrollment process either by accessing a Web site and filling in an online application or by contacting a customer service, consumer 110 provides some information, such as his mobile device information, his starting transaction sequence number (or other dynamic identifier), his security phrase or image, and/or his advertisement preferences. The merchant 130 or a different merchant may also provide information about advertisements that it wishes to send with various alert messages. The secure alert messaging system 100 can use this information and transaction data to generate and deliver the secure alert messages to the consumer 110. The consumer 110 may access the Web site or contact the issuer 160 to change his preferences at any time.

FIG. 3 illustrates an exemplary process where consumer 110 creates and/or updates his user profile through the enrollment process. Consumer 110 first needs to log into an enrollment server (which may be present in Web services 220) by providing his login ID and password to Web services 220 (step 310). After the consumer 110 inputs his login ID and password, the login ID and password are then validated. If the consumer's login information is validated, the consumer 110 may then select a property to add or update (step 320).

When the consumer 110 adds or updates his account information, an enrollment server sends a query to the database to determine whether the account information for the consumer already exists in the enrollment database (step 330). If no record is found, an empty form can be displayed for the consumer to fill in the information. On the other hand, if a record already exists in the database, a form that is prefilled with the existing account information can be displayed on the Website so that the consumer 110 can update his information (step 332). The consumer 110 then fills in or updates information on the forms (step 334), and submits the change for the enrollment server to update the database with the information the consumer provided (step 370).

In some embodiments of the invention, the consumer 110 may provide information regarding his mobile device 200 such as its make and model number and the entity that is the carrier for the wireless service of that mobile device 200. In one embodiment, the consumer 110 may only provide a phone number associated with the mobile device 200, and the issuer 160 or payment processing network 150 can determine the entity that provides wireless service for that mobile device 200. In addition to the information regarding the mobile device 200, the consumer 110 may set some preferences regarding the language and preferred delivery channels for the secure alert message. For example, consumer 110 may specify during the enrollment process that he would like to receive the secure alert messages in a particular language. Consumer 110 may also specify that he would like to receive the secure alert messages on his mobile device 200, or at a particular e-mail address.

In some embodiments of the invention, consumer 110 may want to provide or update the dynamic identifier for his alert messages during the enrollment process. In other embodiments, an issuer or payment processing organization may provide the dynamic identifier without any input from the consumer 110. In the former case, the enrollment server sends a query to the database to determine whether the dynamic identifier for the consumer has been already set up in the enrollment database (step 340). If no record is found, a dynamic identifier form can be displayed for the consumer to fill in the information. In one embodiment, default values provided by the enrollment server are displayed. If a record already exists in the database, a form that is prefilled with the existing dynamic identifier settings will be displayed on the Website for the consumer to update (step 342). Consumer 110 then updates information on the forms (step 344), and submits the change for the enrollment to update the database with the information the consumer provided (step 370). In one embodiment, default settings for the dynamic identifier are provided for the consumer if the consumer does not set up his dynamic identifier settings during enrollment process. In another embodiment, dynamic identifier settings include a starting value and logic to get next value. In still another embodiment, consumer 110 may reset the dynamic identifier value to its starting value.

In some embodiments of the invention, the dynamic identifier may be in the form of sequence number. The secure alert messaging system 100 may provide a default starting sequence number and increment value for consumer 110. The consumer 110 may elect to use these default settings if he wishes. Consumer 110 may also change the sequence properties. Consumer 110 may also reset the current sequence value to the starting value.

In some other embodiments of the invention, the dynamic identifier may be a letter that may change. The secure alert messaging system 100 may provide a default starting letter for consumer 110. The consumer 110 may elect to use this default setting if he wishes. Consumer 110 may also change the sequence properties. Consumer 110 may also reset the current sequence value to the starting value.

In certain embodiments of the invention, consumer 110 may want to set up or update the security phrase/image for his alert messages during the enrollment process. The enrollment server sends a query to the database to determine whether the security phrase/image for the consumer has been already set up in the enrollment database (step 350). If the security phrase/image has not been set up yet, consumer 110 may select a personal security phrase for alert messages from a list of existing security phrases provided by the enrollment server during enrollment process (step 352). Consumer 110 may also create his own security phrase. In some embodiments of the invention, consumer 110 may also select an image as his security image for alert messages from a set of images provided by the enrollment server (step 354). Consumer 100 may also upload his own image as his personal security image. The uploaded image is stored in the enrollment database and is associated with the consumer profile. On the other hand, if the security phrase/image for the consumer has already been set up, the existing settings can be displayed on the Web page for the consumer to update. Consumer 110 then submits the change for the enrollment server to update the database with the information the consumer provided (step 370).

In certain embodiments of the invention, consumer 110 may want to set up or update his preferences regarding the receipt of advertisements in any secure alert messages. The enrollment server sends a query to the database to determine whether the advertisement preferences for the consumer have been already set up in the enrollment database (step 360). If the advertisement preference has not been set up yet, consumer 110 may select one or more categories of advertisements he wishes to receive on alert messages sent to him (step 362). For instance, the consumer 110 may like coffee, so he elects to receive advertisements for coffee shops. If the advertisement preference has been already set up, the existing settings will be displayed on the Web page for the consumer to update. Consumer 110 then submits the change for the enrollment server to update the database with the information the consumer provided (step 370). In other embodiments, advertisements can be sent in secure alert messages regardless of whether consumer preferences are present.

Merchant 130 may also provide its preferences during the enrollment process either by accessing a Web site and filling in an online application or by contacting Web services 220. Ads that are to be placed on the secure alert messages may be chosen based on various merchant preferences, consumer preferences, and transaction data.

The information that the consumer 110 provides is stored in the database 173, as shown in FIG. 2, and can be used to generate secure alert messages. The information that the merchant 130 provides is also stored in the database 173 in the form of merchant enrollment data 177.

### B. Conducting Transactions and Sending Secure Alert Messages

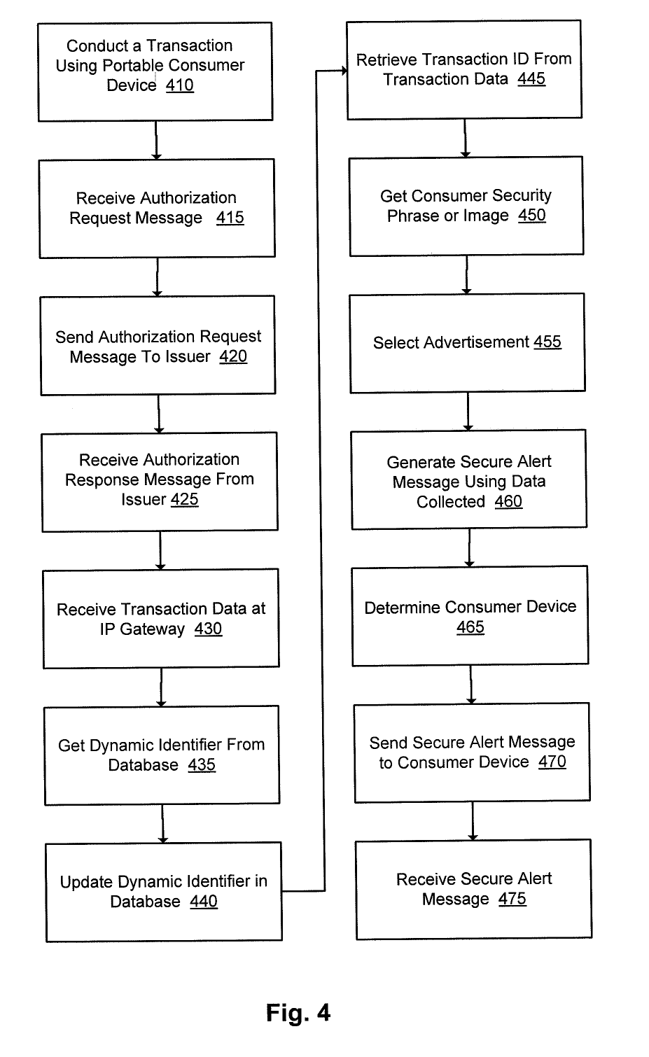

Methods for conducting transactions and sending secure alert messages can be described with reference to FIGS. 1, 2, and 4.

In a typical purchase transaction, consumer 110 purchases goods or services at merchant 130 using the portable consumer device 120 (arrow 1 in FIG. 1, step 410). An authorization request message comprising transaction data is generated by a processor in the access device 132 after the portable consumer device 120 interacts with the access device 132. The authorization request message may comprise, for example, the BIN (bank identification number) and expiration date associated with the portable consumer device 120, the purchase amount, and a merchant code such as a merchant category code (MCC). The authorization request message is then forwarded from the merchant 130 to the acquirer 140 (arrow 2 in FIG. 1). After receiving the authorization request message, acquirer 140 then sends the authorization request message to the payment process network 150 (arrow 3 in FIG. 1, step 415).

The payment processing network 150 then forwards the authorization request message to the issuer 160 (arrow 4 in FIG. 1, step 420). After the issuer 160 receives the authorization request message, the issuer 160 sends an authorization response back to the payment processing network 150 to indicate whether or not the current transaction is authorized (or not authorized) (arrow 5 in FIG. 1).

After the payment processing network 150 receives the authorization response (step 425), it then forwards the authorization response to the acquirer 140 (arrow 6 in FIG. 1). The acquirer 140 then sends the response to merchant 130 (arrow 7 in FIG. 1), and it is then presented to consumer 110 (arrow 8 in FIG. 1).

If consumer 110 is enrolled in the secure alert messaging service, payment processing network 150 sends the transaction data to IP gateway 170 (arrow 6b in FIG. 1). This can occur after the authorization response message is received at the payment processing network 150 and before the authorization response message is forwarded to the acquirer 140. In order for payment processing network 150 to determine whether the transaction is associated with a portable consumer device 120 that is enrolled in the secure alert messaging service, payment processing network 150 maintains a list of account numbers associated with consumers who are enrolled in the secure alert messaging service in the enrollment database 152. The data in the enrollment database 152 are synchronized with the appropriate portion(s) of the consumer enrollment data 176 via synchronization link 156 which may be in any suitable form. For example, the synchronization link 156 may be in the form of a local area network connection or Internet. This can be done so that authorization request messages that are not supposed to receive alerts processing do not receive alerts processing.

After payment processing network 150 receives an authorization response from the issuer 160, an application program, running on a server computer (not shown) in payment processing network 150, compares the account number associated with the authorization request (or the authorization response) with a list of enrolled account numbers in the enrollment database 152. If there is a match, which indicates that the account number associated with portable consumer device 120 is enrolled in the secure alert messaging service, payment processing network 150 sends the transaction data associated with that particular transaction to IP gateway 170.

After IP gateway 170 receives the transaction data from payment processing network 150 (step 430), the notification server computer 171 begins the process of generating a secure alert message for that transaction. During this process, regular processing for transaction authorization continues as normal with the issuer, while at the same time the transaction is inspected and compared to pre-established selected triggers and preferences. The secure alert messages are generated and delivered in real time or near real time to the consumer 110. Many times the secure alert message is received before the consumer 110 leaves a checkout counter at the merchant 130.

The transaction data received from the payment processing network 150 contains information such as an account number associated with the portable consumer device 120, the name of the merchant 130, a merchant identifier such as a merchant category code or MCC, a transaction identifier and the amount of the transaction. The transaction data may also contain other information such as the location of the merchant 130. In some embodiments, the transaction data may not contain all of the information needed to identify some aspect of the transaction such as the location of the merchant 130. However, the transaction data contains processing codes and reference numbers that may be used to acquire further information regarding a transaction.

After receiving the transaction data, the notification server computer 171 analyzes the transaction data. Certain data elements (such as the account number and merchant identifier) in the transaction data are extracted from the transaction data. The notification server computer 171 then accesses database 173 to retrieve alert preference data based on values of these data elements. At step 435, the notification server computer 171 accesses dynamic identifier data 174 to retrieve the dynamic identifier for the consumer based on the account number. After retrieval of the current value of dynamic identifier, the dynamic identifier in the database is updated to its next value (step 440). For example, if the current value of dynamic identifier is 20, the increment value is 1, after the update, the new value of dynamic identifier is 21. In one embodiment of the invention, the transaction identifier is also retrieved from the dynamic identifier data 174 to be used in generating a secure alert message (step 445).

In certain embodiments of the invention, the notification server computer 171 may retrieve a consumer security phrase or image from consumer enrollment data 176 in enrollment database based on the account number (step 450). In one embodiment, only the security phrase is retrieved to generate a secure alert message. In another embodiment, only the security image is retrieved. In still another embodiment, both the security phrase and the security image are retrieved to generate the secure alert message,

In certain embodiments of the invention, the notification server computer 171 may select an advertisement from merchant enrollment data 175 in enrollment database 173 (step 455). The selection is based on both the consumer preferences and merchant preferences stored in the enrollment database. For example, if the consumer only wants to receive ads from local coffee stores, the notification server computer then only searches for those ads from coffee shops that have a store local to the location where the transaction was conducted. The advertisement selection may also be based on transaction data, such as the value of the transaction, type of the transaction, or the location where the transaction occurred. For instance, if a transaction takes place in France, an advertisement from Carrefour™ would probably appear on an alert message instead of a Walmart™ ad.

In some embodiments, the notification server computer may also retrieve the issuer data. The issuer data may include the name and address of the issuer, a phone number to contact, and the issuer's logo, etc. In one embodiment, the issuer data may be stored in the database 173. In another embodiment, the issuer data may reside in a remote database. In still another embodiment, the issuer data may be sent to the IP gateway 170 by the payment processing network 150. The issuer data may be used in generating a secure alert message.

After accessing the alert preference data and determining the technical requirements and consumer and merchant preferences, the notification server computer 171 generates a secure alert message (step 460). This secure alert message generation is performed by a processor using a software application stored in the computer readable medium 172 that is running on the notification server computer 171. In one embodiment, there may be more than one software application running on the notification server computer 171 and working in concert to access various resources such as database 173 to generate the secure alert messages. In another embodiment, some functions may be performed by an Application Specific Integrated Circuit (ASIC) that may be part of the notification server computer 171. In some other embodiments, the secure alert messages may be generated by the combination of software applications and ASICs.

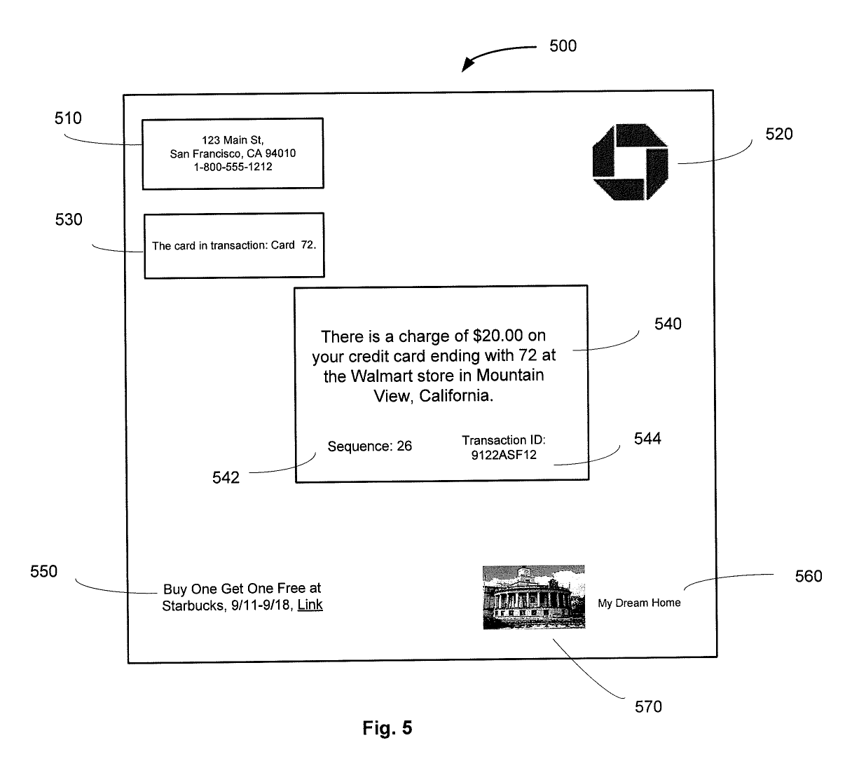

FIG. 5 shows an exemplary secure alert message 500 sent to consumer 110 according to embodiments of the invention. In certain embodiments of the present invention, an alert message 500 provides the alert sender information 510 for a consumer to identify the sender of the alert message. For example, an alert message 500 may contain the name and address of the sender. An alert message may also contain the phone number of the sender for the consumer to contact the sender if he desires. In certain embodiments, a secure alert message 500 may include a logo 520 of the sender, further identifying the sender.

The secure alert message 500 may also include account information 530 to identify the account involved in the transaction. The account information on the alert message may clearly identify the account associated with the transaction. In one embodiment, the account information on the alert does not include the full and complete account number in order to protect the information if the alert message ever gets lost. For example, an alert message may use a phrase “CRD 72” to identify a credit card account which ends in 72. The IP gateway 170 gets the account number from the transaction data, and uses it to generate a secure alert message.

In certain embodiments, the main body 540 of a secure alert message 500 comprises alert text. The alert text could be any information regarding the associated transaction. In one embodiment, the alert text clearly outlines the transaction occurred to help the consumer identify the transaction. Exemplary alert text may be: “There is a charge of $20.00 on your credit card ending with 72 at the Walmart store in Palo Alto, Calif.” Various tables of different specific messages or message templates may be used to generate a secure alert message. For example, a message template indicating a grocery store might be “You purchased $[insert purchased amount] of groceries at $[insert store name] in $[insert store location].”

In certain embodiments of the invention, a secure alert message 500 may also contain a dynamic identifier 542 for the consumer. In some embodiments, a secure alert message body 540 may also contain a transaction identifier (“ID”) associated with the transaction. The transaction ID is unique to the transaction, and is only known to the issuer. The inclusion of the dynamic identifier and transaction ID helps a consumer to identify the legitimate transactions from any phishing activities, because any phishing message would not have both the correct dynamic identifier and the transaction ID. For example, a consumer has a sequence number 9 for the previous transaction, if the consumer receives an alert message with a sequence number 25, the consumer would know right away the alert message was not sent from a legitimate source.

In some embodiments, a secure alert message 500 may also include an advertisement 560 (or offer) specifically tailored to that consumer. For example, an advertisement from Starbucks™ may appear in an alert message sent to a consumer who elects to have advertisements for coffee shops.

In certain embodiments, a secure alert message may also include a security phrase/image set up by the consumer. The same security phrase/image appears on all secure alert messages sent to that consumer until the consumer changes it. This security feature helps a consumer quickly identify whether the alert message is from a legitimate source.

In situations where the notification server computer 171 generates more than one secure alert message for a transaction based on the preference of more than one delivery channels, each message may be customized based on criteria and requirements of each of the delivery channels. For example, if one secure alert message is being sent to the mobile device 200 in the form of a text message, and another one to the user computer 210 in the form of an e-mail, the notification server computer 171 may include more graphics and data in the e-mail message. In some embodiments, issuer 160 may have different logo formats for use with different delivery channels.

When a secure alert message is generated by the notification server computer 171, it is sent to the delivery channel logic 182 for delivery to the consumer 110 (arrows 6b in FIG. 1). The delivery channel logic 182 may be in the form of one or more software applications running on one or more computers that are tasked with delivery of the secure alert messages to the appropriate delivery channel. In one embodiment, the delivery channel logic may be part of the IP gateway 170. In another embodiment, the delivery channel logic 182 may be a third party entity that receives the secure alert message via network connection 154 and sends it to an appropriate user device.

In one embodiment, the secure alert message may be sent along with an indicator that specifies what form of delivery channel should be used for the delivery of the message. The notification server computer 171 retrieves the indicator from enrollment database (step 465). Delivery channel logic 182 is in communication with mobile device carriers 190 and e-mail servers 180, for sending the secure alert messages in formats that are readable by the mobile device 200 and in the form of e-mail messages that are readable by user computer 210 (step 470).

In some embodiments, an secure alert message may be sent to a user in the form of Interactive Voice Response (IVR), Instant Message (IM), Voicemail, etc. Therefore, FIG. 2 shows that delivery channel logic 182 is in communication with other delivery channels 186 that can deliver the secure alert messages in a variety of formats to a user device.

In some embodiments, the delivery channel logic 182 or the notification server computer 171 may cause the mobile device 200 to play an special audio file with a sound of a “beep” when receiving a secure alert message (step 475). In embodiments where the mobile device 200 and the portable consumer device 120 are incorporated into one physical device where consumer 110 can make a purchase by placing the mobile device 200 in the vicinity of an access device 132 having a wireless transmitter reader, the mobile device 200 plays a “beep” sound when the data from a computer-readable medium in the mobile device 200 are transmitted wirelessly to the access device 132. Shortly thereafter, a secure alert message is generated and sent to the mobile device 200 where it makes a second “beep”, verifying that the transaction has gone through.

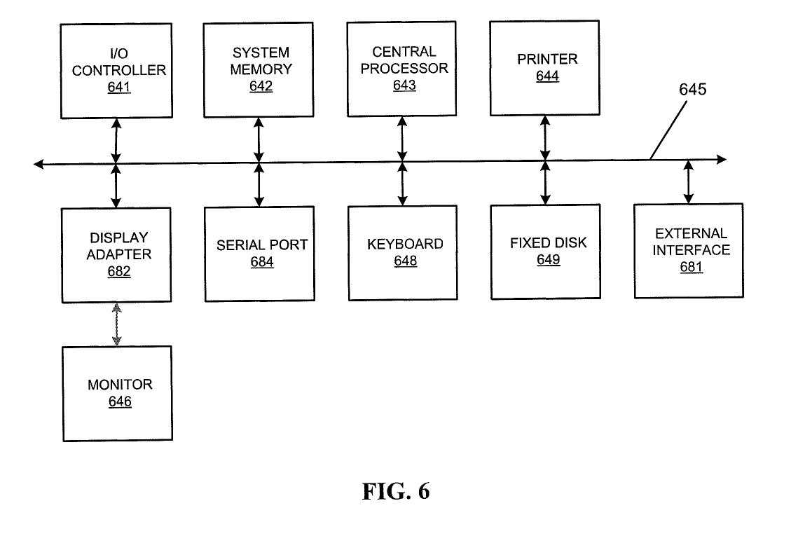

The various participants and elements in FIGS. 1 and 2 may operate one or more computer apparatuses to facilitate the functions described herein. Any of the elements in FIG. 1 or 2 may use any suitable number of subsystems to facilitate the functions described herein. Examples of such subsystems or components are shown in FIG. 6. The subsystems shown in FIG. 6 are interconnected via a system bus 645. Additional subsystems such as printer 644, keyboard 648, fixed disk 649, monitor 646, which is coupled to display adapter 682, and others are shown. Peripherals and input/output (I/O) devices, which couple to I/O controller 641, can be connected to the computer system by any number of means known in the art, such as serial port 684. For example, serial port 684 or external interface 681 can be used to connect the computer apparatus to a wide area network such as the Internet, a mouse input device, or a scanner. The interconnection via system bus 645 allows a central processor 643 to communicate with each subsystem and to control the execution of instructions from system memory 642 or fixed disk 649, as well as the exchange of information between subsystems. The system memory 642 and/or fixed disk 649 may embody a computer readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A notification server computer comprising:
a processor; and
a computer-readable medium coupled to the processor, the computer-readable medium comprising code executable by the processor for implementing a method comprising
receiving transaction data for a transaction,
generating a secure alert message using the transaction data, wherein the secure alert message comprises a dynamic identifier, and
sending the secure alert message to a notification device.

2. The notification server of claim 1, wherein the secure alert message further comprises a transaction identifier associated with the transaction.

3. The notification server of claim 1, wherein the secure alert message further comprises a security phrase or image.

4. The notification server of claim 1, wherein the secure alert message further comprises an advertisement.

5. The notification server of claim 1, wherein the secure alert messaging further comprises a logo.

6. The notification server of claim 1, wherein the transaction data are obtained from an authorization request message or an authorization response message generated in response to the transaction.

7. A method comprising:
receiving transaction data for a transaction;
generating a secure alert message using the transaction data, wherein the secure alert message comprises a dynamic identifier; and
sending the secure alert message to a notification device.

8. The method of claim 7, wherein the secure alert message further comprises a transaction identifier associated with the transaction.

9. The method of claim 7, wherein the secure alert message further comprises a security phrase or image.

10. The method of claim 7, wherein the secure alert message further comprises an advertisement.

11. The method of claim 7, wherein the secure alert message further comprises a logo.

12. A method comprising:
conducting a transaction using an account identifier; and
receiving a secure alert message associated with the transaction at a notification device, wherein the secure alert message comprises a dynamic identifier.

13. The method of claim 12, wherein the secure alert message further comprises a transaction identifier associated with the transaction.

14. The method of claim 12, wherein the secure alert message further comprises a security phrase or image.

15. The method of claim 12, wherein the secure alert message further comprises an advertisement.

16. The method of claim 12, wherein the secure alert message further comprises a logo.
